(19) United States
(12) Patent Application Publication
(10) Pub. No.: US 2009/0296866 A1
(43) Pub. Date: Dec. 3, 2009

(54) EFFICIENT MECHANISMS FOR LOCAL CLUSTER NETWORK SYNCHONIZATION

(76) Inventor: Hsiang-Tsuen Hsieh, San Diego, CA (US)

Correspondence Address: MERLE W. RICHMAN, III, P.O. BOX 3333, LA JOLLA, CA, 92038, US

(21) Appl. No.: 12/132,577

(22) Filed: Jun. 3, 2008

(51) Int. Cl. H04L 7/00

(52) U.S. Cl. 375/371

(57) ABSTRACT

Embodiments of local cluster network synchronization in mechanisms are described generally herein. Other embodiments may be described and claimed.

### TECHNICAL FIELD

Various embodiments described herein relate to digital communications generally, including apparatus, systems, and methods used in wireless communications.

### BACKGROUND INFORMATION

There is a need for a simplified local cluster network synchronization mechanism for multiple devices in the network.

### BRIEF DESCRIPTION OF THE DRAWINGS

FIG. 1 is a block diagram of a wireless positioning architecture comprising wireless devices according to various embodiments.

FIG. 2 is a diagram of a wireless positioning sub-network or local cluster according to various embodiments.

FIGS. 3A to 3D are diagrams of chirp formats 100, 110, 120, and 130 in various embodiments.

FIGS. 4A to 4D depict an example of the sampling time offset 176 between a master base station 16 transmit burst 110 and a slave base station 120.

FIG. 5 is a flow diagram illustrating several methods according to various embodiments.

FIG. 6 is a block diagram of a slave base station 18 module according to various embodiments.

FIG. 7 is a block diagram of a WD 32 according to various embodiments.

FIG. 8 is a block diagram of a base station 16, 18 according to various embodiments.

### DETAILED DESCRIPTION

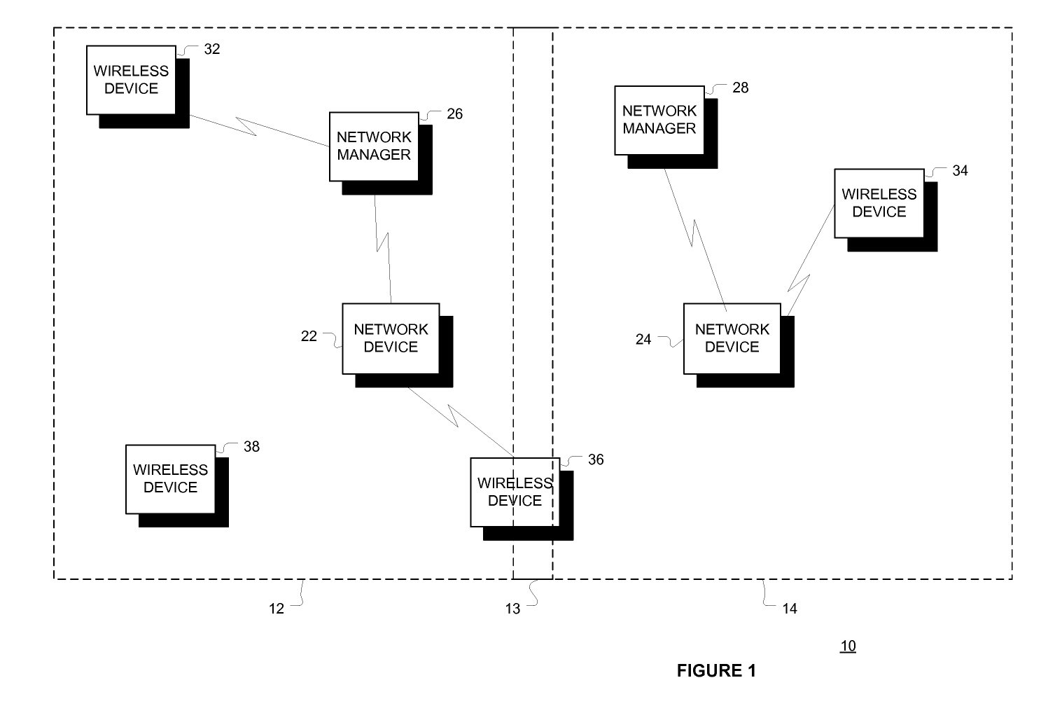

FIG. 1 is a block diagram of a wireless positioning architecture 10 comprising wireless devices (“WD”) 32, 34, 36, 38, network devices (“ND”) 22, 24, and network managers (“NM”) 26, 28 according to various embodiments. Each WD 32, 34, 36, 38 may be able to establish a wireless connection between itself and one or more ND 22, 24 and network manager 26, 28. Each ND 22, 24 may be able to establish a wireless connection between itself and one or more WD 32, 34, 36, 38 and network manager 26, 28. In an embodiment a NM 26, 28 may be part of a ND 22, 24. The WD 32, 34, 36, 38, the ND 22, 24, and the NM 26, 28 may be capable of operating according to an IEEE 802.1x family of standards, using a Code Division Multiple Access (CDMA) standards. Bluetooth®, or any other wireless communication protocol or standard. In an embodiment, architecture 10 may include several sub-networks or local cluster networks 12, 14. There may be an overlap 13 between the sub-networks or local cluster networks 12, 14.

In architecture 10 WD 32, 36, 38 may be located in sub-network or cluster 12 and WD 34 may be located in cluster 14. WD 32, 34, 36 may communicate with one or more ND 22 and NM 26 in the cluster 12. WD 34 may communicate with one or more ND 24 and NM 28 in cluster 14. In an embodiment, the network manager 26, 28 may manage data communications between different local cluster networks 12, 14, network devices 22, 24 inside each local cluster network 12, 14 and WD 32, 34, 36, 38. A network manager 26, 28 may communicate and distribute network synchronization information among different local clusters 12, 14, the WD 32, 34, 36, 38, and the ND 22, 24 including synchronization among different local clusters 12, 14 and the synchronization within a single local cluster 12, 14 (between ND 22, 24 and WD 32, 34, 36, 38). In an embodiment a WD 32, 34, 36, 38 users positioning and navigation may be supported by an individual local cluster network 12, 14 when the WD 32, 34, 36, 38 is physically located within a particular local cluster 12, 14. Further, when a WD 32, 34, 36, 38 moves from one local cluster network 12, 14 coverage area to another local cluster network 12, 14, the WD positioning and navigation service may be transitioned to the new local cluster network 12, 14 via a NM 26, 28. The boundaries of neighboring local cluster networks may be overlapped 13 to enable continuous positioning and navigation service for WD 32, 34, 36, 38. In an embodiment the network manager NM 26, 28 may communicate information including positioning and navigation data with other network devices 22, 24 using a data communication channel. This data communication channel can be implemented using existing available technology including wireless and wired technology such as a land line network (e.g. Ethernet) or a wireless network.

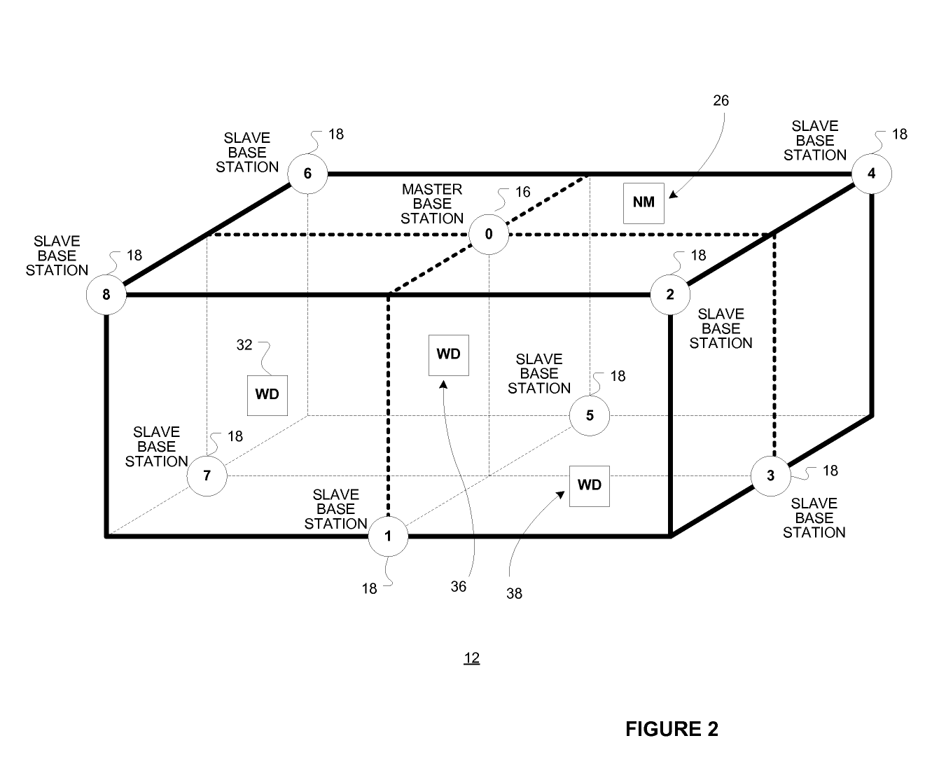

FIG. 2 is a diagram of a wireless positioning sub-network or local cluster 12, 14 according to various embodiments. The local cluster 12, 14 may include multiple base stations 16, 18 including at least one master base station 16 and several slave base stations 18. In an embodiment a single local cluster network 12, 14 may include a master base station and from 3 to N slave base stations with a minimum of 3 slave base stations. The master base station may be assigned an ID of 0 and a slave base station 18 may be assigned an ID of 1 to N when there are N slave base stations. The base stations 16, 18 may be fixed position devices where the position of each base station 16, 18 is known by the network 12, 14 or NM 26, 28. In an embodiment N may be up to 12. The position of each base station in a 3 dimensional grid may be represented in an orthogonal coordinate system such Cartesian coordinates, x, y and z.

In an embodiment the master base station 16 of a cluster 12 may provide the timing and frequency reference for all devices 18, 32, 34, 36, 38 within a local cluster 12, 14. FIG. 2 is a diagram of a base station 16, 18 configuration according to an embodiment of a single local cluster network 12 that supports WD 32, 36, 38 positioning and navigation in 3-D space. The local cluster 12 includes 8 slave base stations where 4 additional slave base stations may be positioned anywhere inside or around the local cluster coverage area to limit dead spots of positioning service. The distribution of the master base station 16 and the slave stations 18 may depend on the service area environment and the layout of other objects and building structures. In an embodiment, the local cluster network 12, 14 is configured to enable the master base station's 16 transmitted signal to be received by other local cluster devices 18 including WD 32, 36, 38. Each slave base station 18 should be able to receive the master base station's 16 transmitted signal in a local cluster or sub-network 12, 14. The master base station 16 may be located in the geographic center of the local cluster 12, 14 service area in an embodiment. Further, a WD 32, 36, 38 may receive signals from at least 4 base stations in order to determine its position in 3-D space.

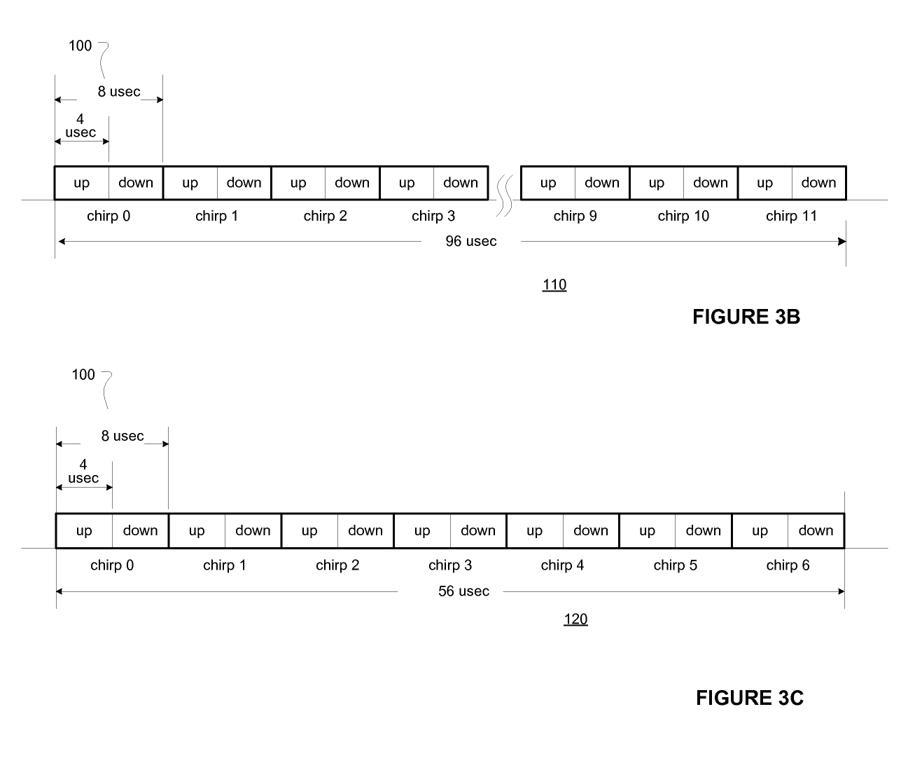

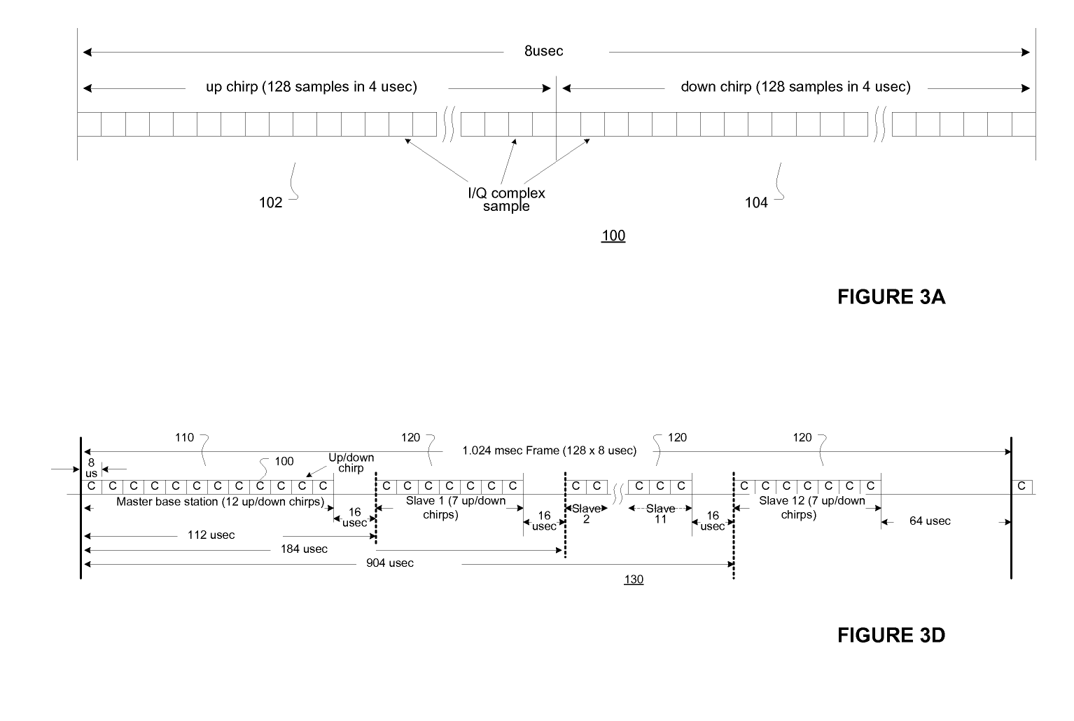

FIGS. 3A to 3D are diagrams of chirp formats 100, 110, 120, and 130 in various embodiments. In local cluster network 12, 14 embodiment, each base station may transmit a signal burst in an assigned time slot including a series of up/down chirps 102, 104. As shown in FIG. 3A each up chirp group and down chirp group may include a predetermined number of In-phase/Quadrature (I/Q) samples, 128 samples in an embodiment. In an embodiment where the sampling rate is 32 MHz the duration of a up group 102 or a down chirp group 104 may be 4 μsec each. In an embodiment a local cluster 12, 14 master base station 16 and each slave base station 18 may use the up and down chirp waveform or chirp template 100 to form their respective transmit signal bursts.

In an embodiment, the number of up/down chirp waveforms 100 transmitted by a master base station 16 may be different than the number of chirp waveforms 100 transmitted by a slave base station. Such a configuration may enable a network device 32, 34, 36, 38, 18 to distinguish a master base station's transmit signal burst from a corresponding slave base station's signal burst. FIG. 3B is a diagram a master base station 16 transmit signal burst 110 according to various embodiments. The master base station transmit signal burst includes twelve (12) consecutive up/down chirps. Accordingly, the duration of the master base station's signal burst is 96 μsec (12×8 μsec) when the sampling rate is 32 MHz. FIG. 3C is a diagram of a slave base station 18 transmit signal burst 120 according to various embodiments. The slave base station transmit signal burst includes seven (7) consecutive up/down chirps. Accordingly, the duration of the slave base station's 18 signal burst 120 is 56 μsec (7×8 μsec) when the sampling rate is 32 MHz.

FIG. 3D is a diagram of a full transmission burst according to various embodiments. The full transmission burst 130 is a 1.024 msec frame when the sampling rate is 32 MHz. The full transmission burst 130 includes the master base station burst 110 followed by up to 12 base station bursts 110. Each base station burst 110, 120 is separated by 16 μsec and last base station burst is followed by a 64 μsec gap. In an embodiment the full transmission burst 130 is repeated every 1.024 msec. The frame timing and the 8 μsec chirp waveform 110 durations may be defined by the master base station transmitted signal 110 portion of the overall full transmission burst 130. In an embodiment other network devices 32, 34, 36, 38, 18 associated with a local cluster 12, 14 may synchronize to the reference provided by the master base station's 16 transmission burst 110.

In detail in an embodiment a master base station 16 starts transmission at the beginning of the full burst frame 130. After the twelve (12) up/down chirps waveforms 100, a first slave base station waits for the length of two chirp waverforms 100 (16 μsec in an embodiment) and then starts transmission of seven (7) chirp waveforms (at 112 μsec after the frame burst 130 start). A second slave base station may wait for the length of two chirp waverforms 100 (16 μsec in an embodiment) after the completion of the first slave base station 18 burst 120 and then start transmission of seven (7) chirp waveforms 120 (at 184 μsec after the frame burst 130 start). Accordingly, the twelfth slave base station #12 may start transmission of seven (7) chirp waveforms 120 904 μsec after the frame start. There may be a 64 μsec gap between the end of the twelfth slave base station's transmission burst 120 and the next full burst frame 130 boundary.

In an embodiment a local cluster network may not have twelve slave base stations 18 installed. In such an embodiment the corresponding time slot(s) assigned to an un-installed slave base station in a full burst 130 may be empty during transmission. In an embodiment each base station ID 16, 18 and position in a local cluster network 16, 18 may be maintained by a NM 26, 28 and distributed to each network device 16, 18, 32, 34, 36, 38 using a data communication channel. Each network device 16, 18, 32, 24, 26, 28 may implement a timing state machine module that counts and tracks the frame 130 timing as well as the 8 μsec chirp waveforms 100 or durations inside a frame 130.

In an embodiment each base stations 16, 18 and WD 32, 34, 36, 38 in a local cluster network 12, 16 may employ their own internal clock module for hardware and software operation where the clocks may not be synchronized. In is noted that there may be offsets among different clock crystals used by the devices 16, 18, 32, 34, 36, 38 where the offset may be measured in parts per million (PPM). Accordingly in an embodiment synchronization of a local cluster network's 12, 14 devices 16, 18, 32, 34, 36, 38 may not be tied to their respective sampling clocks given each device's 16, 18, 32, 34, 36, 38 hardware clock may be free running (independent of other device's clocks).

In an embodiment synchronization between a local network 12, 14 devices 16, 18, 32, 34, 36, 38 may be achieved via frame timing 130 and monitoring the radio frequency (RF) frequency of the burst 130 and its signal phase. In this embodiment a local network's 12, 14 master base station 16 may be the synchronization reference for the local network 12, 14 remaining devices 18, 32, 34, 36, 38. Accordingly, a local cluster network's 12, 14 master base station 16 may not synchronize to any other device in the local network 12, 14. In an embodiment a local cluster network's 12, 14 master base station transmission burst 110 timing defines the frame boundary for devices 18, 32, 34, 36, 38 in the local cluster network 12, 14. Each slave base station 18 and WD 32, 34, 36, 38 in the local cluster network 12, 14 may determine or measure a frame boundary via a correlation and peak detection module 206 along with a chirp waveform phase evaluation module 207 that may be implemented in a baseband receiver in these devices. The design of the correlation and peak detection module 206 and the chirp waveform phase evaluation module 207 is known to those of skill in the art.

After a device 18, 32, 34, 36, 38 determines a full transmission burst 130 frame boundary, the device may track the frame boundary timing by using a counter based on its local clock module pulse. When the device's clock module has an offset relative the master base station's 16 clock module, the frame boundary maintained by the device's local counter may drift relative to the network frame boundary. In an embodiment when the effective offset between the device's local frame boundary and the master base station's 16 frame boundary exceeds a predetermined number of clock cycles, the device 18, 32, 34, 36, 38 may adjust its counter to align its local frame boundary with the network frame boundary to within one clock cycle (in an embodiment when the boundary exceeds one or more clock cycles). The clock jitter effect may not be a constant in one direction and may be smaller than a clock cycle. A device 18, 32, 34, 36, 38 may determine the master base station's 16 frame boundary by evaluating an entire waveform 110 timing and phase (12 up/down chirps in an embodiment), the clock jitter effect at the clock cycle level may be averaged over the longer master base station's chirp waveform 110. Accordingly, a device's clock module jitter may not affect the device's tracking of the master base station's 16 frame boundary when employing an offset counter.

In an embodiment the master base station's 16 frame timing may used by a local cluster network 12, 14 devices 18, 32, 34, 36, 38 to schedule their transmission bursts 120, signal receptions, and other tasks. Further each local cluster network 12, 14 device 18, 32, 34, 36, 38 may measure the frequency offset between its local RF and the master base station's 16 transmitted RF. A local cluster network 12, 14 device 18, 32, 34, 36, 38 may then adjust its RF synthesizer module to match its local RF to the master base station's 16 transmit RF. It is noted that the most of the estimated frequency offset may be corrected or negated by a device's 18, 32, 34, 36, 38 RF synthesizer module being tuned to match the master' base station's RF. Due to the RF synthesizer module adjustment step size, there may be residual RF offset. In an embodiment the residual RF offset to the master base station's RF may be estimated and tracked continuously by each local cluster network 12, 14 device 18, 32, 34, 36, 38.

A local cluster network 12, 14 device 18, 32, 34, 36, 38 may have baseband analog hardware that may shift their respective transmit signal frequency spectrum incrementally by steps as small as several Hertz (Hz). A slave station 18 baseband analog hardware may enable a slave station 18 to fine tune their transmitted signal frequency to more closely match a master station's 16 TX signal. In an embodiment any residual frequency offset between a slave station 18 and master station 16 may be compensated by a slave base station 18 TX waveform phase rotation.

In an embodiment a WD 32, 34, 36, 38 position may be calculated based on Time of Arrival (TOA) measurements of signals received from several known sources 16, 18. The TOA for a received signal may be determined as a function of the received signal's phase offset (difference between the signal phase at a WD 32, 34, 36, 38 versus its phase when transmitted by a device 16, 18. Such an embodiment may require a WD 32, 34, 36, 38 to know the signal phase when transmitted by a device 16, 18. In an embodiment a WD 32, 34, 36, 38 may measure the relative phase difference between signals received from different devices 16, 18 in the local cluster network 12, 14. In an embodiment the RF and phase of a signal transmitted by a slave base station 18 may be identical to the master base station's 16 RF and phase signal in the local network cluster 12, 14. A slave base station's 18 signal may differ from a corresponding master base station's 16 signal in signal power and transmission timing in a frame.

In another embodiment a mobile user's position via a WD 32, 36, 38 may also be determined using Time of Arrival (TOA) measurements from signals transmitted from several fixed base stations. In such an embodiment arrival time measurements at a mobile user of a WD 32, 36, 38 may be subtracted a signal transmission time to determine the corresponding signal propagation time. The signal propagation time may be used to calculate the distance between a WD 32, 36, 38 and a transmitter 16, 18. The spatial position of the mobile user via a WD 32, 36, 38 may be determined to calculated distances of several transmitters 16, 18 (via the TOA). In an embodiment the system 12 transmitted (TX) signal phase synchronization may enable a slave base stations 18 to synchronize with the master base station 16 so each slave station's 18 transmitted signal has the substantially similar waveform phase/timing relative to the respective master's waveform phase/timing. In an embodiment each slave station 18 may transmit data in its own assigned time slot as defined by the master station 16 timing. Accordingly a mobile user via a WD 32, 36, 38 may determine the phase (timing) difference between a signal received from one or more slave station 18 relative to a signal received from a corresponding master station 16. The determined phase differences may be converted to time differences that may be used for various purposes by a WD 32, 36, 38.

In this embodiment each base stations 16, 18 of a local network cluster 12, 14 may have the same signal phase when transmitted. Accordingly a WD 32, 34, 36, 38 may not need to know or determine the absolute phase of signal from base stations 16, 18 when transmitted. The WD 32, 34, 36, 38 may determine the relative phase differences between signals received from different slave stations 18 relative to the signal of a master station 16 of a local cluster network 12, 14. The phase differences determined by a WD 32, 34, 36, 38 may be translated to Difference of Time of Arrivals (dTOA) and be used to calculate each WD 32, 34, 36, 38 position.

It is noted that each digital chirp signal is composed of I/Q samples. In an embodiment before each I/Q sample is sent to a D/A and A/D converter module 212 for transmission in a base station 16, 18 of a local cluster network 12, 14, a phase adjustment may be applied to each I/Q sample to change the phase of the I/Q sample. The entire chirp waveform phase is modified by changing the phase of each I/Q sample with a different amount. The intent is to introduce a time shift, a clock scaling and a frequency adjustment to the chirp waveform while preserve the time-frequency relationship of the chirp and to match the slave base station's signal timing and frequency to the master's signal reference. This process allows a slave base station 18 to synchronize its transmitted signal to the master base station's 16 signal timing and frequency. In an embodiment the phase adjustment amount depends on several parameters including the sampling time offset between the slave base station 18 and the corresponding master base station 16 and the residual RF offset between the slave base station 18 and the master base station 16.

As noted the sampling time offset between a slave base station 18 and the master base station 16 may be defined as the difference of a slave base station's 18 own sampling time and sampling time measured from a signal received from a master base station plus the radio wave propagation delay between a master base station 16 and a slave base station 18. The sampling time offset may be due to several factors including the random time when each device 16, 18 is powered up, the signal propagation over the distance between the master base station 16 and the slave base station 18, the RF and baseband processing delays at two devices 16, 18, the clock drift between the two devices 16, 18, and the clock offset between two devices 16, 18.

In an embodiment a slave base station 18 may perform waveform modification in the frequency domain to achieve a waveform shift in time domain. Based on a Fourier transformation time-frequency domain relationship, a waveform h(t) shifting in time domain by the amount of t0 corresponds to the frequency domain signal H(f) multiplied by the complex vector e^{-j2πft0}, where h(t) and H(f) are the waveform representation in time and frequency domain respectively. In the case of a chirp waveform, the frequency domain representation of a chirp has a linear group delay curve. The slope of the group delay curve controls the frequency sweeping rate of the chirp in time domain. A slave base station may apply a fixed time shift to its transmitted chirp waveform by adding the amount of time shift to the group delay curve at each frequency component. This added time shift to the group delay curve corresponding to the addition of −2πft0 to the phase for the phase component at frequency f. In an embodiment that a slave base station performing digital processing technique, the inverse Fast Fourier Transform (IFFT) can be used to convert the phase modified frequency domain chirp signal to time domain chirp signal for transmission.

In embodiment in order to determine sampling time offset information relevant to the TX waveform phase rotation calculation, a slave station 18 may measure and track the sampling time offset, the clock offset, and the residual frequency offset. The slave station 18 may calculate a running average of the sampling time offset, the clock PPM offset, and the residual frequency offset determined from a signal received from a corresponding master base station 16. In an embodiment the known signal propagation delay between a signal transmitted from the master base station 16 and the slave base station 18 may be calculated.

The known signal propagation delay may be factored into the calculated sampling time difference between the slave local sampling time and the received master signal timing. The propagation delay time from a master base station 16 and to each slave base station 18 may be fixed and a known parameter in an embodiment. A slave station 18 may measure or determine the timing difference of a received master station 16 signal relative to its local sampling timing and add the known propagation delay to calculate the total timing offset.

In an embodiment, to determine the sampling time offset for the phase rotation calculation, a slave station device 18 may measure and track the sampling time offset calculated from a signal received from the master base station 16 and the clock module offset estimated from a signal received from the master station. The measured clock module offset between a slave base station 18 and a master base station 16 is a slow changing parameter that may be affected by the temperature change and aging of a clock crystal in a clock module. In an embodiment the clock module offset may be averaged at a slave station and sent to a NM 26, 28.

In an embodiment, each base station 16, 18 may also measure the clock offsets between its own clock module relative to every other base station 16, 18 in a local cluster network 12, 14. The measured clock module offsets may be individually averaged per base station at each measuring device 16, 18 and sent to a NM 26, 28. A NM 26, 28 may further average data received from each base station 16, 18. A NM 26, 28 may send the averaged clock module offsets to each base station 16, 18. A slave base station 18 may combine the clock module offset estimated locally with the estimates received from the NM 26, 28 to generate the final clock module offset to be used by the phase rotation calculation.

Due to the RF synthesizer tuning module step size the module may not be tuned exactly to a desired frequency. Accordingly the residual frequency offset may exist between a master base station's 16 transmitted frequency and a slave base station's 18 local frequency where any residual frequency offset may be measured by the slave base station 18 based on signals received from a master base station 16. In an embodiment, a slave base station may rotate the phase of its chirp baseband signal to shift the baseband frequency spectrum so that the resultant RF transmit burst 120 will be more closely match the master base station's transmit burst's 110 RF. The transmit burst 120 signal phase rotation may be modified by a slave base station 18 digital baseband transmitter module.

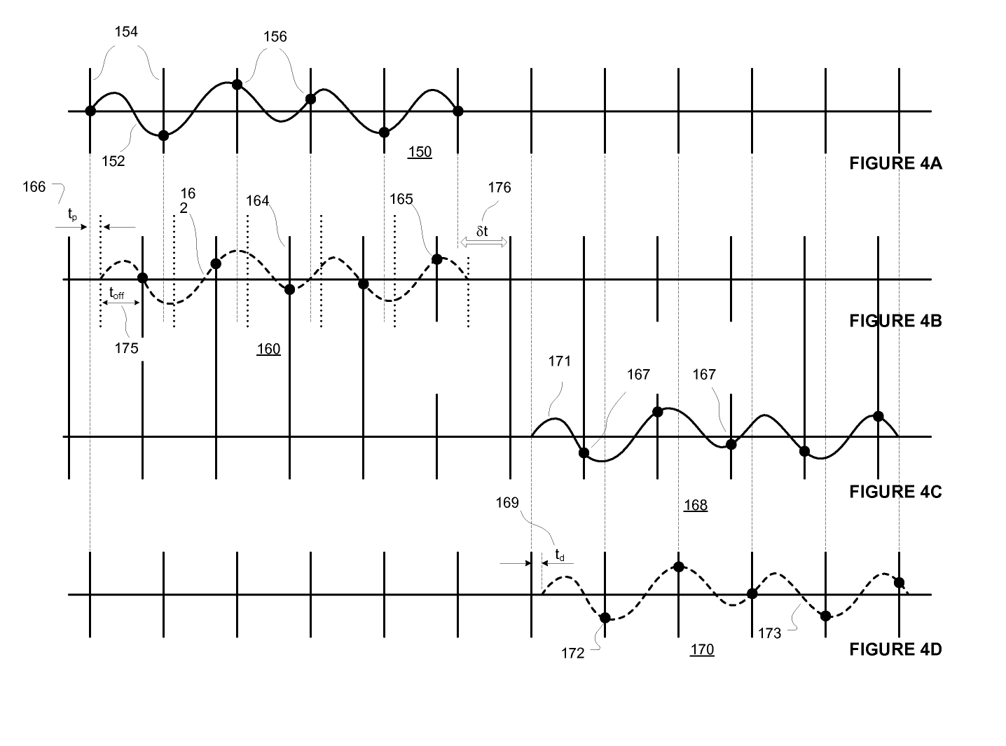

FIGS. 4A to 4D depict an example of the measurable sampling time offset 175, t_{off} between a master base station 16 transmit burst 110 and a slave base station's 18 local timing measured by the slave base station 18. FIG. 4A is a diagram of a signal 150 as transmitted by a master base station 16. FIG. 4B is a diagram of a master TX signal 160 as received by a slave base station 18. FIG. 4C is a diagram of a signal 168 as transmitted by a slave base station 18. FIG. 4D is a diagram of a slave TX signal 170 as received by a master base station 16. The master base station 16 simplified signal 150 includes a waveform 152 sampled at points 154 to generate digital samples 156. FIG. 4B is a diagram of a master base station 16 signal 160 received at a slave base station 18. The signal 160 includes a waveform 162 sampled at points 164 to generate samples 165. As shown the master base station 16 signal has a known propagation delay 166, tₚ. It is noted that the total sampling time offset (the true sampling time offset) δt between a slave station 18 and master station 16 is equal to the sum of the known propagation delay, tₚ. and the measurable sampling time offset t_{off}.

In this embodiment a slave base station transmitted signal 168 (see FIG. 4C) may still be sampled 167 at different times than the corresponding master base station 16 signal 150 timing 154 due to the slave base station's 18 internal clock. In an embodiment a slave base station 18 transmitted signal 168 may be phase adjusted to correct for the slave base station's 18 local clock so the waveform's 168 phase is aligned to the master base station's sampling clock 154 at the instant when a waveform 168 leaves the slave base station 18. In this embodiment a master base station 16 may receive a slave base station's transmitted signal 170 and determine (by measuring) the propagation delay, t_{d} 169 based on a received slave base station signal 170 (see FIG. 4D). In this embodiment the master base station 16, directly or via a NM 26, 28 may communicate the propagation delay, t_{d} 169 value to a respective slave base station 18.

Accordingly δt 176 is the total sampling time offset to be estimated by a slave station 18 based on a signal transmitted by a master base station 16. The total sampling time δt includes the two components t_{off}: and tₚ (δt=t_{off}+tₚ) where t_{off} is the timing offset estimated by the slave station strictly from the signal received from a master station 16 and tₚ is the signal propagation delay between a master station 16 and a corresponding slave station 18. The propagation delay tₚ is a known, fixed parameter when distance between a master base station 16 and a corresponding slave station is relatively constant. As noted a master base station 16 may estimate the timing offset between a received slave base station 18 signal and its own local timing. The estimated timing difference t_{d} 169 may represent the signal propagation delay tₚ from a slave station 18 to a master station 16. When the estimated timing difference t_{d} and the propagation delay tₚ are not equal, the difference or propagation error tₑ may be feedback to a slave base station 18. The slave base station may correct the estimated timing offset δt based on the propagation error tₑ, in particular where δ̅t̅=δt−tₑ.

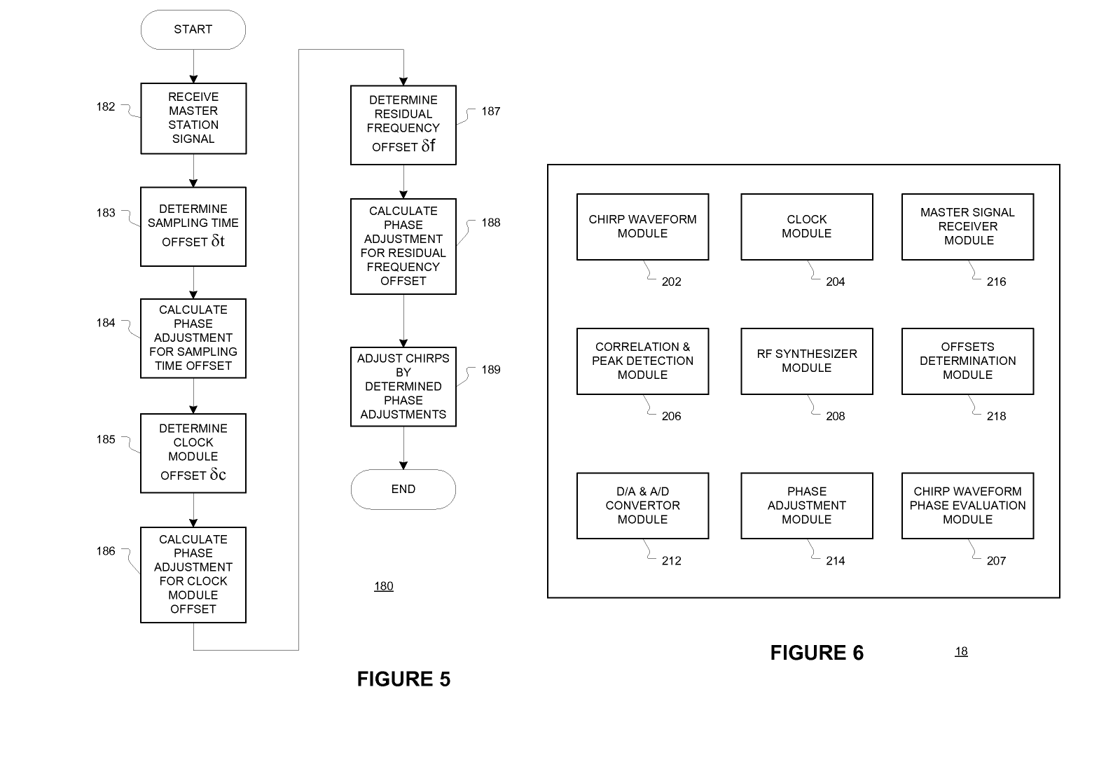

In an embodiment the method 180 shown in FIG. 5 may be employed to adjust a slave base station transmit burst 120 for a sampling time offset 176. The method 180 may first receive a master base station 16 transmit burst 110 (activity 182). The method may then determine the sampling time offset δt (activity 183) based on the received master base station transmit burst 110. It is noted that the propagation delay 166 is known since the position of the master base station 16 and respective slave base station 18 are physically fixed at least prior to the master base station transmit burst 110. The method 180 may calculate the phase adjustment for the determined sampling time offset δt of the slave transmit burst signal 120 (activity 184). When the sampling time offset is δt the amount of phase rotation needed for the k^{th} sample in the slave base station 18 transmit signal burst 120 due to the sampling time offset is:

θₜ(k)=sgn_chirp×2π×(k×Δf+δf)×δt

where (a) k=0, 1, 2, . . . , N−1 and N is 1792 in FIG. 4B; (b) sgn_chirp=+1 for the up chirp and −1 for the down chirp (the chirp sign); (c) Δf is the frequency increment of the up chirp waveform 102 during each sampling time; and (d) δf is the residual frequency offset measurement. In an embodiment the value δf may be very small compared to k×Δf. When k equals 0, the remaining value θₜ(0)=2π×δf×δt is also small compared to θₜ(k) for k≠0. Accordingly, the term δf may be neglected when determining the phase rotation in an embodiment. It is noted that the value of sgn_chirp×2π×Δf is constant. The value sgn_chirp×2π×Δf may be calculated at the beginning of each up or down chirp 102, 104 and the resultant phase θₜ(k) calculated for each transmitted I/Q sample of the slave transmit burst 120.

The method may then determine the clock module offset δc between a slave base station 18 and a master base station 16 (activity 185). In an embodiment the clock module offset δc between a slave base station 18 and a master base station 16 may be determined (in PPM). The method 180 may calculate the phase adjustment for the clock module offset δc of the slave transmit burst signal 120 (activity 186). The additional phase rotation amount needed for the k^{th} sample in a transmitted signal burst 120 due to the clock module offset δc is:

$${θ}_{c} ( k ) = sgn\_chirp \times 2 π \times ( k \times Δ f + δ f ) \times \frac{k}{R} \times \frac{δ c}{1000000}$$

where R is the transmit signal sampling rate. As noted the value δf is very small compared with k×Δf and the term δf may be neglected when determining the phase rotation for the clock module offset in an embodiment. The value sgn_chirp×2π×Δf×δc/(1000000×R) is constant and may be calculated at the beginning of a up or down chirp waveform 102, 104 and the resultant phase θ_{c}(k) calculated for each transmitted I/Q sample of the slave transmit burst 120. The phase θ_{c}(k) will be calculated for each transmitted I/Q sample.

Depending on a system positioning accuracy requirement, engineering design methodology, and the clock crystal module stability, the phase adjustment θ_{c}(k) may be neglected when the resultant positioning accuracy error by the clock module offset δc is much smaller than the required positioning accuracy. At any given time, a slave base station 18 may determine whether the calculation of θ_{c}(k) and the phase adjustment using θ_{c}(k) may be skipped by comparing the value of the measured clock module offset δc with a predetermined threshold where the threshold is related to the positioning accuracy requirement. This threshold may be established by a calibration method.

The method may determine the residual frequency offset δf between a slave base station 18 and a master base station 16 (activity 187). The method 180 may calculate the phase adjustment for the residual frequency offset δf of the slave transmit burst signal 120 (activity 188). In an embodiment the residual frequency offset δf between the slave station and the master station may be:

δf=master_{—}TX_frequency−slave_local_frequency

The amount of phase rotation needed for the k^{th} sample in the transmitted signal burst due to the residual frequency offset δf may be:

$${θ}_{f} ( k ) = 2 π \times ( k \times \frac{δ f}{R} + ( \frac{k \times δ c}{1000000 \times R} + δ t ) \times δ f )$$

The value k×δc/(1000000×R) may be small when the clock module offset δc is small and may be neglected in calculation of θ_{f}(k) (e.g. when the positioning accuracy is 30 cm in an embodiment using sampling rate R=32,000,000 sample/second with maximum k less than 2000 and the measured clock module offset δc is less than 1 PPM). The value 2π×δf×δt and 2π×δf/R may be constant values and may be calculated at the beginning of a slave base station 18 transmission burst 120.

In an embodiment the phase adjustment value θ_{f}(k) may be neglected when the resultant positioning accuracy error due to the residual frequency offset δf is much smaller that the desired positioning accuracy. At any given time, a slave base station 18 may determine whether the calculation of θ_{f}(k) and the phase adjustment using θ_{f}(k) may be skipped by comparing the value of the measured residual frequency offset δf with a predetermined threshold where the threshold is related to the desired positioning accuracy. This threshold may be established by the calibration method.

After the calculation of θₜ(k), θ_{c}(k) and θ_{f}(k) in each sampling time, the amount of the total phase rotation needed is: Δθ(k)=θₜ(k)+θ_{c}(k)+θ_{f}(k). The method 180 may adjust the phase of each chirp of a chirp waveform 100 for a slave base station 18 signal burst 120 based on Δθ (activity 189) prior to a slave base station 18 signal transmission 120 in a local cluster network 12, 14. In an embodiment the resultant phase rotation may be performed via a Cordic algorithm or table look up.

FIG. 6 is a block diagram of a slave base station 18 according to various embodiments. The slave base station 18 may include several modules including a chirp waveform module 202, clock module 204, correlation and peak detection module 206, chirp waveform phase evaluation module 207, RF synthesizer module 208, digital to analog (D/A) and analog to digital (A/D) convertor module 212, phase adjustment module 214, master base station signal receiver module 216, offsets determination module 218. The chirp waveform module 202 may generate the up and down chirp waveforms 102, 104 for the slave base station 18 transmit burst 120. The chirp waveform module 202 may apply a phase offset determined by the phase adjustment module 214. The offsets determination module 218 may determine the sampling time offset, clock module offset, and the residential frequency offsets. The clock module 204 may generate the local clock signal for the slave base station 18. The master base station signal receiver 216 may receive or process master base station transmit bursts 110 and work in conjunction with the offsets determination module 218 to determine the offsets based on a received master base station transmit burst signal 110.

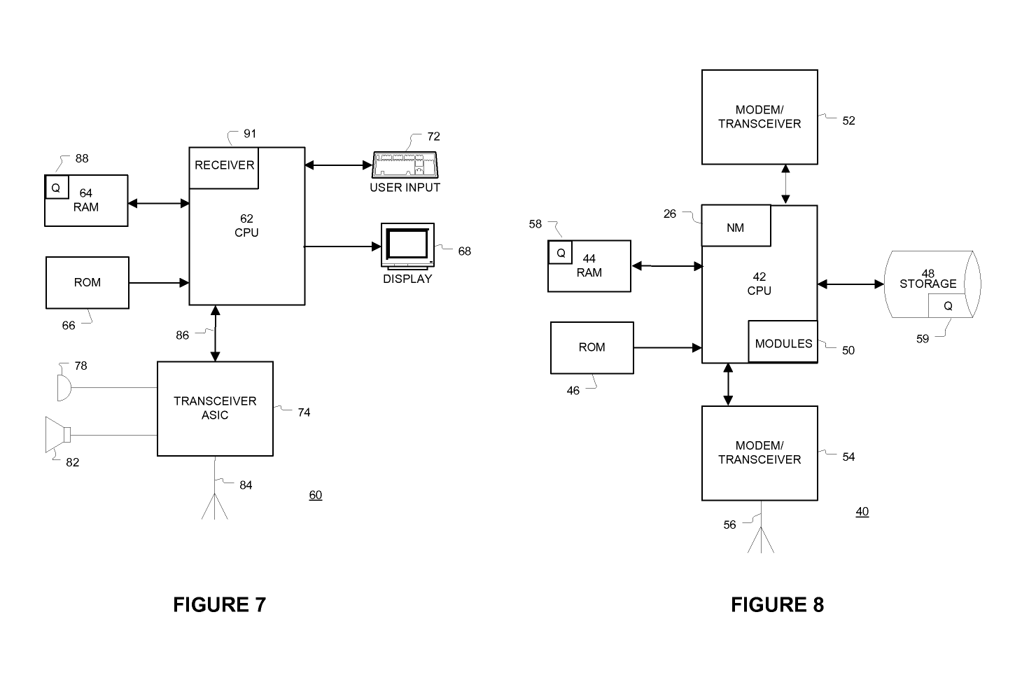

A device 60 is shown in FIG. 7 that may be used in various embodiments as a wireless device (WD) 32, 34, 36, 38. The device 60 may include a central processing unit (CPU) 62, a random access memory (RAM) 64, a read only memory (ROM″) 66, a display 68, a user input device 72, a transceiver application specific integrated circuit (ASIC) 74, a microphone 78, a speaker 82, and an antenna 84. The CPU 62 may include a receiver 91. The RAM 64 may be include a queue 88 where the queue 88 is used to store the differential time of arrival (dTOA) information determined from received transmit burst signals 110, 120. The receiver 91 may be used to process signals received by the transceiver ASIC 74 and to determine dTOA for received base stations 16, 18 transmit burst signals 110, 120.

The ROM 66 is coupled to the CPU 62 and may store the program instructions executed by the CPU 62 and receiver 91. The RAM 64 is coupled to the CPU 62 and stores temporary program data, overhead information, and queues 88. The user input device 72 may comprise an input device such as a keypad, touch pad screen, track ball or other similar input device that allows the user to navigate through menus in order to operate the device 60. The display 68 may be an output device such as a CRT, LCD or other similar screen display that enables the user to read, view, or hear received, processed data packets.

The microphone 78 and speaker 82 may be incorporated into the device 60. The microphone 78 and speaker 82 may also be separated from the device 60. Received data may be transmitted to the CPU 62 via a serial or parallel bus 86 where the data may include packets received, packets to be transmitted, hardware control/status signals, hardware clock signals, or protocol information. The transceiver ASIC 74 may include an instruction set necessary to communicate data signals over the wireless architecture 10. In one embodiment, the transceiver ASIC 74 is capable of communicating over a WiMAX, CDMA, IEEE 802.1x, Bluetooth, or other wireless protocol enabled network. The ASIC 74 may be coupled to the antenna 84 to communicate signals within the architecture 10. When a data signal is received by the transceiver ASIC 74, the data is transferred to the CPU 62 via the serial or parallel bus 86. The data can include base station protocol, overhead information, and packets to be processed by the device 60 in accordance with the methods described herein.

FIG. 8 illustrates a block diagram of a device 40 may be employed as a slave base station 18 or master base station 16 in various embodiments. The device 40 may include a CPU 42, a RAM 44, a ROM 46, a storage unit 48, a first modem/transceiver 52 and a second modem/transceiver 54. The CPU 42 may include modules 50 (such as shown in FIG. 6) and a network manager 26. The RAM 64 may include a queue 58 where the queue 58 may be used to storage information about received communication signals including transmit burst signals 110, 120, 130. The storage 48 may also include a queue 59 where the queue 59 may be used to store information about received communication signals including transmit burst signals 110, 120, 130. In an embodiment the NM 26 and the modules 50 may be separate elements. Further the NM 26 may be a separate device 40 in an embodiment.

The modules 50 may include a chirp waveform module 202, clock module 204, correlation and peak detection module 206, chirp waveform phase evaluation module 207, RF synthesizer module 208, D/A and A/D module 212, phase adjustment module 214, master base station signal receiver module 216, chirp offsets determination module 218. The chirp waveform module 202 may generate the up and down chirp waveforms 102, 104 for the slave base station 18 transmit burst 120. The chirp waveform module 202 may apply a phase offset determined by the phase adjustment module 214. The offsets determination module 218 may determine the sampling time offset, clock module offset, and the residential frequency offsets. The clock module 204 may generate the local clock signal for the slave base station 18. The master base station signal receiver 216 may receive or process master base station transmit bursts 110 and work in conjunction with the offsets determination module 218 to determine the offsets based on a received master base station transmit burst signal 110.

The first modem/transceiver 52 may couple, in a well-known manner, the device 40 to an Internet connection or via a wired telephone system such as the Plain Old Telephone System (POTS). The second modem/transceiver 54 may couple the device 40 to other devices 32, 34, 36, 38, 16, 18, 26 in architecture 10. The modem/transceiver 54 may be a wireless modem or other communication device that communicates with WD 32, 34, 36, 38, base station 16, 18, or network manager 26 in the architecture 10 (FIG. 1). The CPU 42 via the scheduler 50 may direct communication between the first and second modem, 52 and 54, respectively, for messages between the Internet, or POTS, and one or more WDs, base stations 16, 18, or network manager 26.

The ROM 46 may store program instructions to be executed by the CPU 42, NM 26, or modules 50. The RAM 44 and storage 48 may be used to store temporary program information, network information, signal processing intermediate calculation data, estimated offsets, wireless protocols, queues, and overhead information for other base stations in its sector (i.e., nearby base stations 16, 18). The storage device 48 may comprise any convenient form of data storage and may be used to store the overhead information, wireless protocols, and queues.

Any of the components previously described can be implemented in a number of ways, including embodiments in software. Thus, the CPU 42, modules 50, NM 26, modem/transceiver 54, modem/transceiver 52, antenna 56, storage 48, RAM 44, ROM 46, queue 58, queue 59, CPU 62, receiver 91, transceiver ASIC 74, antenna 84, microphone 78, speaker 82, ROM 66, RAM 64, queue 88, user input 72, display 68, BS 16, 18, WD 32, 34, 36, and 38 may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments. The apparatus and systems of various embodiments may be useful in applications other than positioning systems. The embodiments are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. And, various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

Although the inventive concept may include embodiments described in the exemplary context of an IEEE standard 802.xx implementation (e.g., 802.11, 802.11a, 802.11b, 802.11E, 802.11g, 802.16, etc.), the claims are not so limited. Additional information regarding the IEEE 802.11a protocol standard may be found in IEEE Std 802.11a, Supplement to IEEE Standard for Information technology—Telecommunications and information exchange between systems—Local and metropolitan area networks—Specific requirements Part 11: Wireless LAN Medium Access Control (MAC) and Physical Layer (PHY) specifications—High-speed Physical Layer in the 5 GHz Band (published 1999; reaffirmed Jun. 12, 2003). Additional information regarding the IEEE 802.11b protocol standard may be found in IEEE Std 802.11b, Supplement to IEEE Standard for Information technology—Telecommunications and information exchange between systems—Local and metropolitan area networks-Specific requirements—Part 11: Wireless LAN Medium Access Control (MAC) and Physical Layer (PHY) specifications: Higher-Speed Physical Layer Extension in the 2.4 GHz Band (approved Sep. 16, 1999; reaffirmed Jun. 12, 2003). Additional information regarding the IEEE 802.11g protocol standard may be found in IEEE Std 802.11g, IEEE Standard for Information technology—Telecommunications and information exchange between systems—Local and metropolitan area networks—Specific requirements Part 11: Wireless LAN Medium Access Control (MAC) and Physical Layer (PHY) specifications Amendment 4: Further Higher Data Rate Extension in the 2.4 GHz Band (approved Jun. 12, 2003). Embodiments of the present invention may be implemented as part of any wired or wireless system. Examples may also include embodiments comprising multi-carrier wireless communication channels (e.g., orthogonal frequency division multiplexing (OFDM), discrete multitone (DMT), etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The present invention may be used as part of a high accuracy positioning and navigation system. An embodiment may provide timing and frequency information to distributed wireless network devices using a master-slave structure. In an embodiment, a networks may consist of multiple base stations with fixed positions relative to each other. Each base station may transmit deterministic RF signal whose timing (including signal phase) and frequency are synchronized to a master base station. The positioning network may provide high accuracy positioning and navigation inside the network coverage area using difference of Time of Arrival technique (dTOA) for mobile users.

The present invention is not limited to applications in positioning and navigation. The present invention network synchronization may be employed to deliver reliable and high quality network service in a high speed wireless communication networks with distributed network devices. A poorly synchronized wireless communication network may be less efficiency in network operation and provide lower Quality of Service (QoS) to the network users. The timing accuracy and precision achievable by the present invention may be used for nano-second grade configurations. For a wireless network with relatively fixed devices, network timing and frequency synchronization may be achieved by measuring the master base station's signal parameters. The invention synchronization may be further refined by the master base station measuring each slave station's signal and providing feedback measurements to the slave stations. The slave stations may modify or correct their synchronization for as a function of the feedback measurements.

For a network with mobile devices that may function as slave devices, network timing and frequency synchronization may be achieved by measuring the master base station's signal parameters, employ network positioning/navigation, factor any propagation delay, and determine a Doppler shift based on each mobile device's position and speed. This configuration may allow mobile network devices to be synchronized to a master's timing and frequency.

The invention synchronization technique may be employed for transmission scheduling in wireless networks to prevent or limit transmission signal collisions from multiple transmitters and to support priority based transmission of data from various sources with different priorities or service levels. In wireless sensor networks, the invention synchronization technique may improve coordination among sensors to increase efficiency and reduce interference among sensors. The invention synchronization technique may reduce the complexity of the mobile device design and provide high accuracy and precision of position estimation.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A wireless signal generation module of a first device, including:
a receiver to receive a wireless signal from a second device;
an offset determination module to determine one or more offsets between the first device and the second device based on the received wireless signal; and
a phase modification module to modify the phase of a signal to be transmitted by the first device based on determined one or more offsets.

2. The signal generation module of a first device of claim 1, further comprising a transmitter module to wirelessly transmit a phase modified signal, the phase modified signal having a reduced offset between the first device and the second device.

3. The signal generation module of a first device of claim 1, wherein the second device provides an indication of an offset between the first device and the second device based on a signal received from the first device and the offset determination module to determine one or more offsets between the first device and the second device based on the received wireless signal and the indication.

4. The signal generation module of a first device of claim 2, wherein wireless signal received from the second device includes a plurality and up and down chirp waveforms and the phase modified signal includes a plurality and up and down chirp waveforms.

5. The signal generation module of a first device of claim 2, wherein an offset represents a sample offset differential between the first device and the second device.

6. The signal generation module of a first device of claim 2, wherein the wireless signal received from the second device has an RF carrier and an offset represents a residual RF carrier offset differential between the first device and the second device.

7. The signal generation module of a first device of claim 2, further comprising a clock module to generate a local clock signal and wherein an offset represents a clock signal differential between the first device local clock and the second device.

8. The signal generation module of a first device of claim 3, wherein the up and down chirp waveforms include a plurality of in-phase and quadrature components.

9. The signal generation module of a first device of claim 2, wherein the transmitter module has a relatively fixed physical location.

10. The signal generation module of a first device of claim 2, wherein the second device has a transmitter module that generates the received wireless signal and the second device transmitter module has a relatively fixed spatial distance from the wireless signal generation module transmitter module.

11. A method including,
at a wireless signal generation module of a first device, receiving a wireless signal from a second device;
determining one or more offsets between the first device and the second device based on the received wireless signal; and
modifying the phase of a signal to be transmitted by the first device based on determined one or more offsets.

12. The method of claim 11, further comprising wirelessly transmitting a phase modified signal and wherein the phase modified signal has a reduced offset between the first device and the second device.

13. The method of claim 11, wherein the second device provides an indication of an offset between the first device and the second device based on a signal received from the first device and determining one or more offsets between the first device and the second device based on the received wireless signal and the indication.

14. The method of claim 12, wherein wireless signal received from the second device includes a plurality and up and down chirp waveforms and the phase modified signal includes a plurality and up and down chirp waveforms.

15. The method of claim 12, wherein an offset represents a sample offset differential between the first device and the second device.

16. The method of claim 12, wherein the wireless signal received from the second device has an RF carrier and an offset represents a residual RF carrier offset differential between the first device and the second device.

17. The method of claim 12, further comprising generating a local clock signal and wherein an offset represents a clock signal differential between the first device local clock signal and the second device.

18. The method of claim 13, wherein the up and down chirp waveforms include a plurality of in-phase and quadrature components.

19. The method of claim 12, wherein the transmitted signal is transmitted from a relatively fixed physical location.

20. The method of claim 12, wherein the second device generates the received wireless signal from a relatively fixed spatial distance where the transmitted signal is transmitted.

21. An article including a machine-accessible medium having associated information, wherein the information, when accessed, results in a machine performing:
at a wireless signal generation module of a first device, receiving a wireless signal from a second device;
determining one or more offsets between the first device and the second device based on the received wireless signal; and
modifying the phase of a signal to be transmitted by the first device based on determined one or more offsets.

22. The article of claim 21, wherein the information, when accessed, results in a machine performing:
at the wireless signal generation module of a first device, wirelessly transmitting a phase modified signal and wherein the phase modified signal has a reduced offset between the first device and the second device.

23. The article of claim 21, wherein the second device provides an indication of an offset between the first device and the second device based on a signal received from the first device and determining one or more offsets between the first device and the second device based on the received wireless signal and the indication.

24. The article of claim 22, wherein wireless signal received from the second device includes a plurality and up and down chirp waveforms and the phase modified signal includes a plurality and up and down chirp waveforms.

25. The article of claim 22, wherein an offset represents a sample offset differential between the first device and the second device.
